(19) United States
(12) Patent Application Publication
(10) Pub. No.: US 2002/0149628 A1
(43) Pub. Date: Oct. 17, 2002

(54) Positioning an item in three dimensions via a graphical representation

(76) Inventors: Jeffrey C. Smith, Ellicott City, MD (US); James W. Nash, Bromma (SE)

Correspondence Address: KLARQUIST SPARKMAN CAMPBELL LEIGH & WHINSTON, LLP, One World Trade Center, Suite 1600, 121 S.W. Salmon Street, Portland, OR, 97204, US

(21) Appl. No.: 09/745,696

(22) Filed: Dec. 22, 2000

(51) Int. Cl. G06F 3/00

(52) U.S. Cl. 345/848

(57) ABSTRACT

A graphical representation representing at least a portion of an observable three-dimensional space is presented. A user can select a location on the graphical representation to direct a moveable item to a three-dimensional location within the space corresponding to the location selected by the user. Calibration operations can be performed, and error correction information can be generated to avoid mechanical error. Manipulation devices using non-orthogonal coordinate systems can be supported. Multiple items can be positioned on a specimen viewed under a microscope, and an item such as an electrode can be positioned within a living biological specimen

### FIELD OF THE INVENTION

This invention relates to accurately positioning an item within a three-dimensional space observable under a microscope, such as by placing an item at a position in three-dimensional space corresponding to a location selected within a graphical representation presented by a computer.

### BACKGROUND OF THE INVENTION

The art of biological research is often advanced by experiments performed on microscopic living specimens and their cells. Living specimens may be as small as a few microns, so experiments performed on them require specialized equipment that can perform delicate manipulations with precise tools having micron accuracy.

To perform an experiment involving a very small specimen, a researcher typically views the specimen through a microscope and moves an item such as a probe or tool via a micromanipulator under manual control. Typically, a joystick can be used to assist the researcher in guiding the item, but the researcher must practice and develop skill with the joystick to successfully perform micro scale manipulations.

Therefore, it would be helpful to provide a method and system for improving micromanipulation of items at a microscopic level.

### SUMMARY OF THE DISCLOSURE

In one embodiment disclosed herein, an item can be positioned within a three-dimensional space observable under a microscope. A graphical representation of at least a portion of the three-dimensional space is presented, and a location within the graphical representation can be selected. Responsive to receiving the selection, information about the selected location within the graphical representation is transformed into appropriate signals to position the item at a physical location in three-dimensional space corresponding to the selected location.

Possible graphical representations include an image, a volume rendering, a graphical surface rendering, a stereoscopic image, and the like. If the three-dimensional space contains a specimen, such as a biological specimen, the item can be, for example, positioned at a location within the biological specimen.

This is in contrast to prior approaches that rely upon the motor skills of an operator to correctly position an item, such as that described in Miura et al., U.S. Pat. No. 5,677,709, filed Feb. 7, 1995, entitled “Micromanipulator System with Multi-Direction Control Joy Stick and Precision Control Means,” which is hereby incorporated herein by reference.

The automated approach described herein is particularly advantageous when inserting an item under the surface of a specimen. Due to the way items are moved with micromanipulators, positioning an item at a sub-surface location within a microscope's field of view (e.g., 100 micrometers under the surface) might require insertion of the item at a location outside the field of view (e.g., 250 micrometers away in an x direction from its ultimate destination). Thus, the approach described herein is a useful automation of a process that is prone to difficulty and possible damage to the specimen when attempted manually.

The technology described herein is particularly applicable to experiments involving living tissue. For example, plural electrodes can be applied to brain tissue.

In described embodiments, the graphical representation is a captured image depicting a field of view observed by a microscope, and a user selects a location within the image via a graphical user interface (e.g., by clicking on the location). A focus location associated with the field of view is implicitly associated with the graphical representation. Values indicating the three-dimensional location are calculated via the implicit value and coordinates of the selected location within the image.

In certain embodiments, a safe move feature allows an item to be moved without damaging a specimen in the three-dimensional space. For example, an operator can specify a certain location above the microscope stage above which it is believed to be safe to move the item without coming into contact with the specimen.

Certain disclosed embodiments also include a calibration feature by which calibration information is collected. Error-correcting features avoid calibration error, mechanical error, and other error associated with microscopic manipulation of items.

Certain features can be implemented to support a manipulation device having a non-orthogonal coordinate system.

The foregoing and other features and advantages of the invention will become more apparent from the following detailed description of disclosed embodiments which proceeds with reference to the accompanying drawings.

### BRIEF DESCRIPTION OF THE FIGURES

FIG. 1 is a block diagram of a system suitable for positioning an item within a three-dimensional space observable under a microscope at a location indicated via a computer user interface.

FIG. 2 is a screen shot of a user interface for indicating where within a specimen an item is to be located.

FIG. 3 is a screen shot of the user interface of FIG. 2 showing an item that has been placed at the indicated location.

FIG. 4 is a flow chart showing a method for positioning an item in a three-dimensional space at a location indicated by selecting a point on a displayed image.

FIG. 5 is a view showing a coordinate system used for a computer user interface.

FIG. 6 is a view showing a coordinate system used for specifying a point in three-dimensional space under a microscope.

FIG. 7 is a flow chart showing a method for calibration.

FIG. 8 is an illustration of a manipulator having a declined drive axis.

FIG. 9 is an illustration of rotation of a manipulator with respect to a microscope stage.

FIG. 10 is an illustration of various coordinate systems for use in an exemplary implementation.

FIG. 11 is a screen shot of a control window that is presented as part of a user interface.

FIG. 12 is a screen shot of an image window that is presented as part of a user interface allowing an operator to select a location on an image to position an item at a location associated with the selected location.

FIG. 13 is a diagram of a numeric keypad and arrow keys showing key assignments to particular functionality.

### DETAILED DESCRIPTION OF EXEMPLARY EMBODIMENTS

The present invention includes a method and apparatus for positioning a moveable item at an indicated location within a three-dimensional space (or “volume”) viewed under a microscope.

### Exemplary Automated Microscope and Computer System

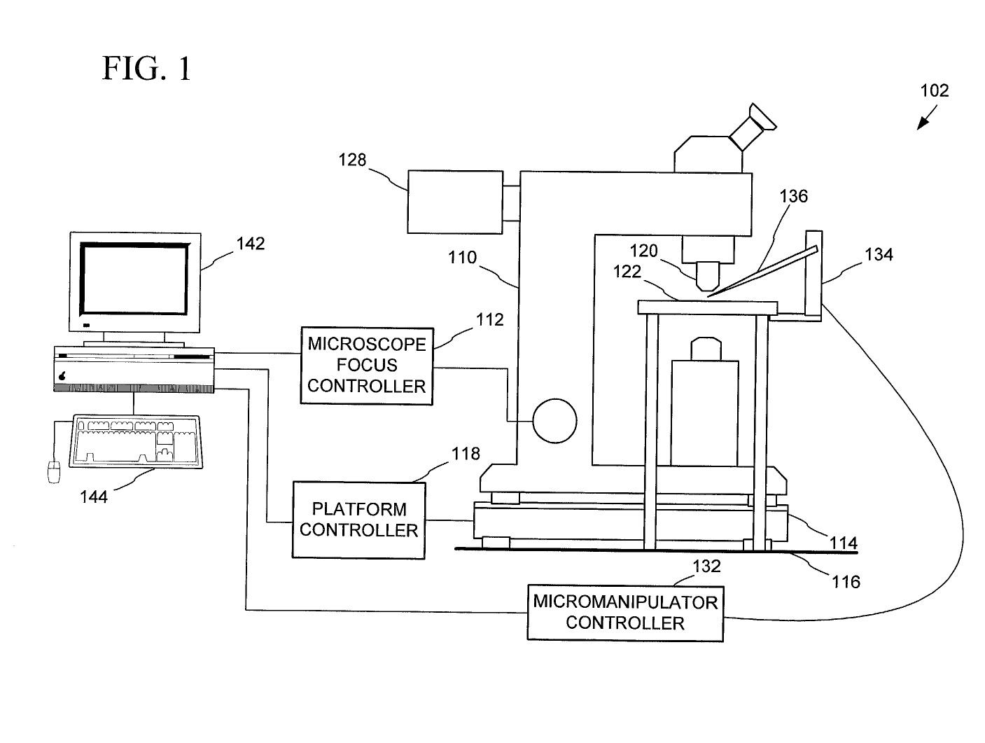

FIG. 1 shows an exemplary system 102 suitable for carrying out the invention. The exemplary system includes an automated optical microscope 110 controlled by a microscope focus controller 112. The system 102 also features a motorized platform 114, which rests on a table 116 and is controlled by a platform controller 118. The motorized platform 114 can move the microscope relative to a fixed stage 122. Movement of the microscope 110 (to which the objective 120 is attached), moves the microscope's field of view.

A camera 128 can be used to capture an image representing the microscope's field of view, and a micromanipulator controller 132 can be used to control a micromanipulator 134, which can manipulate an item 136, such as a probe, electrode, light guide, or drug injection pipette. The exemplary system also includes a microcomputer 142, including input devices 144, such as a keyboard and a pointing device (e.g., mouse or trackball).

As shown in FIG. 1, the system can be arranged so that the stage is fixed and the microscope is moved. Alternatively, the stage may be motorized and move the item and the micro-manipulators relative to the microscope. In such an arrangement, the motorized stage is made stable enough to support the micromanipulators because the micromanipulators are attached to the stage. The phenomenon of inertial movement should be avoided. Inertial movement can occur when the stage accelerates and the micromanipulators tend to stay at rest due to their mass. The arrangement of FIG. 1 has the advantages of avoiding inertial movement and vibration. In either arrangement, the item 136 is positionable at a location in three-dimensional space.

The exemplary system 102 is automated and computer implemented in that it also includes, in addition to the motorized microscope platform 114, a microscope platform controller 118 for controlling movement of the motorized microscope platform 114, typically in response to a command directed to the microscope platform controller 118. There is also a microscope focus controller 112 for automated focusing. An example of a microscope that can be modified to perform at least some of these functions is manufactured by Carl Zeiss, Inc. of Germany. The microscope can include a variety of objective lenses suitable for viewing items at objective magnifications between 5× and 63×, such as 5×, 40×, and 63×.

In particular embodiments, the microscope is of the AXIOSKOP line of microscopes from Carl Zeiss, Inc.; however, a variety of other microscopes can be used, such as the Laser Scanning Microscope LSM 510 from Carl Zeiss, Inc., a confocal microscope from Atto Instruments of Rockville Md., such as that shown in PCT WO 99/22261, which is hereby incorporated herein by reference, or others. For example, any microscope that has a motorized focus controller can be used, whether the motor for the focus control is coupled to the microscope focus control or the objective. For stable results, the motor for the focus control can be directly coupled rather than coupled through a friction clutch. A piezo-electric or other computer-controllable focus mechanism is suitable.

An example of a camera 128 suitable for use is any camera supporting the RS-170 image format or a digital camera, such as the QUANTIX camera available from Roper Scientific MASD, Inc. of San Diego, Calif. or others.

In particular embodiments, the micromanipulator 134 and the manipulator controller 132 (collectively called a “micromanipulator system”) are commercially-available units from Eppendorf, Inc., of Hamburg, Germany, such as the INJECTMAN micromanipulator or the Micromanipulator 5171, which can be adapted to a wide variety of commonly-used inverted microscopes. Other suitable micromanipulators and controllers include those manufactured by Luigs & Neumann of Germany, Mertzhauser, and Sutter Instrument Company of Novato, Calif. (e.g., the MP-285 Robotic Micromanipulator). The micromanipulator system is operable to receive three-dimensional information (e.g., a motor position) indicating a location within the three-dimensional space viewed under the microscope 110 and direct an item thereto.

Although one item 136 is shown in the example, more than one (e.g., four) can be used at a time. The items can be, for example, probes, electrodes, light guides, and drug injection pipettes.

The computer 142 can be any of a number of systems, such as a MACINTOSH POWERPC computer with a PCI bus and running the MACOS operating system from Apple Computer, Inc. of Cupertino, Calif. an INTEL (e.g., PENTIUM) machine running the WINDOWS operating system from Microsoft Corporation of Redmond, Wash. or a system running the LINUX operating system available from various sites on the Internet. Other configurations are possible, and the listed systems are meant to be examples only. As described in more detail below, the computer is programmed with software comprising computer-executable instructions, data structures, and the like. The computer presents a graphical representation of at least a portion of the three-dimensional space viewable under the microscope 110 and serves as a converter for converting an indicated location on the representation into three-dimensional information indicating the location within the three-dimensional space.

The depicted devices include computer-readable media such as a hard disk to provide storage of data, data structures, computer-executable instructions, and the like. Other types of media which are readable by a computer, such as a removable magnetic disks, CDs, DVDs, magnetic cassettes, flash memory cards, and the like, may be used.

To process the output of the camera 128, the computer 142 can include, for example, an LG-3, VG-5, or AG-5 image capture board from Scion Corporation of Frederick, Md., which can operate in any computer supporting PCI. A variety of other arrangements using TWAIN, QUICKTIME, or FIREWIRE technology or a direct digital camera can be used. The image sampling rate in the examples is ten frames per second or better.

The components of the system 102 can be connected using a variety of techniques, such as RS-232 connections. In some cases, such as the typical MACINTOSH POWERPC computer, the computer can be expanded to accommodate additional serial ports. For example, products (e.g., the LIGHTNING-PCI board or SEQS peripheral) from Creative Solutions of Hanover, Md., can add four serial ports (e.g., ports C, D, E, and F) to accommodate controllers for multiple items as well as the microscope platform and focus controllers. In some cases, connections to certain manipulator controllers may need to be modified. For example, in the case of a device from Cell Robotics International of Albuquerque, N. Mex. pins 1 and 2 were removed to avoid configuration conflicts. In another example, in the case of a LUIGS & NEUMANN manipulator, an acceleration profile can be burned into the EEPROMs.

### Exemplary Overview of Operation

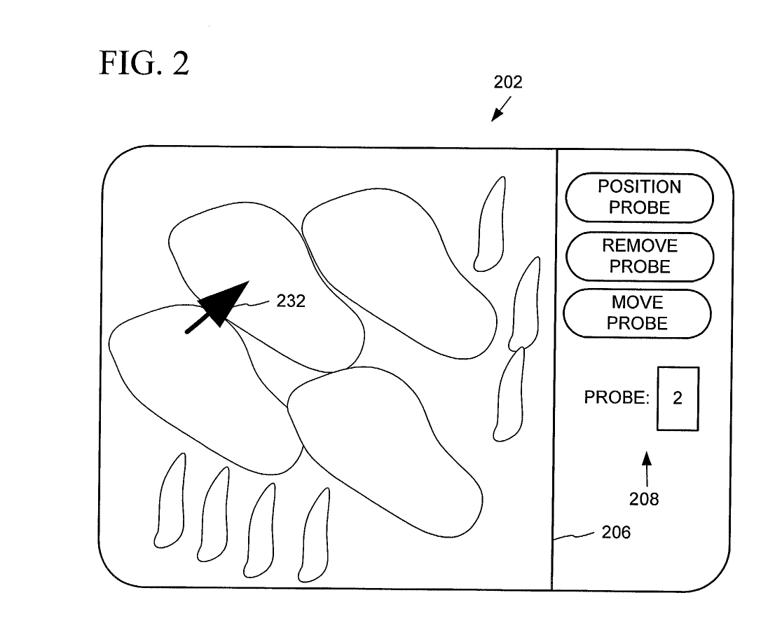

FIG. 2 shows a screen shot 202 presented during operation of an exemplary embodiment. The screen shot 202 can be presented, for example, on the monitor of a computer system, such as that in the computer system 142 of FIG. 1. Although a black-and-white image is shown in the example, the system can be configured to present a color image.

The screen shot 202 includes a displayed portion of an image generated from the output of a camera (e.g., the camera 122 of FIG. 1) viewing a microscope's field of view. The image is thus a graphical representation of at least a portion of the three-dimensional space observable by the microscope, and, in the example, the image is a two-dimensional graphical representation of a slice of the space.

In some embodiments, the three-dimensional space includes a biological specimen (e.g., brain, nerve, or muscle tissue, a brain slice, a complete brain, an oocyte, or another biological preparation), and the displayed portion 206 thus is a graphical representation (e.g., an image) of a portion of the biological specimen. The image can be refreshed at a rate that provides a near real-time view of the biological specimen. Exemplary user interface controls 208 enable a user to operate the system and select various functions. In the example, a user presses the “POSITION PROBE” button via a pointing device (e.g., a mouse or trackball), and then indicates a location on the image portion 206 by moving the pointer 232 and activating (e.g., clicking) the pointing device.

Responsive to receiving the user indication of the location on the image, the system transforms the location on the image portion 206 (e.g., the X and Y coordinate) and the focus location of the microscope to a position with respect to (e.g., on or within) the specimen in three-dimensional space and directs the probe to the location with respect to the specimen corresponding to the location on the image. In the example relating to a biological specimen, an electrode (e.g., for measuring electrical signals) is typically positioned at the location on or within the biological specimen corresponding to the location on the image.

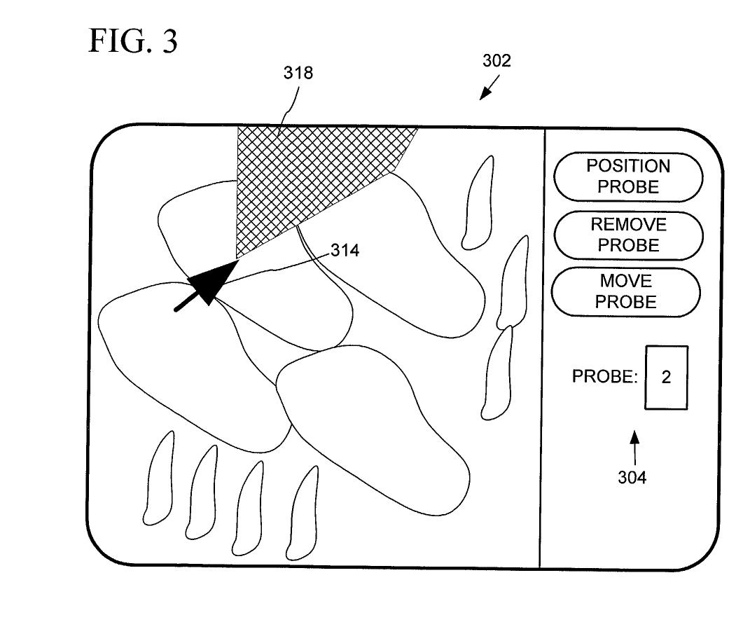

FIG. 3 shows a screen shot 302 similar to FIG. 2, including the user interface controls 304 and the pointer 314. FIG. 3 additionally shows that the probe 318 has been successfully positioned at the desired location. The operator can thus manipulate the position of the probe in real time while viewing constantly updated (e.g., live) images of the specimen under the microscope.

The advantages to such an arrangement include the ability to actively monitor progress of an experiment or manipulation involving living tissue. For example, it can be determined whether the probe has adversely affected the specimen or has been positioned at an undesirable location within the specimen. The operator can thus adjust actions in light of information gleaned from the image.

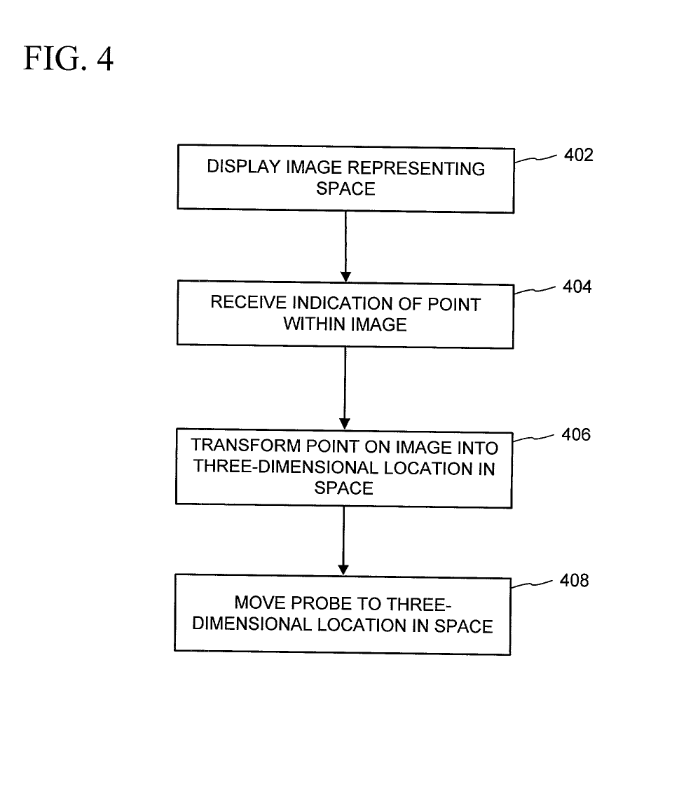

FIG. 4 shows an overview of a method for positioning an item at a location within the three-dimensional space and can be implemented via software. In the example, the software could be written in the Pascal language, but any number of other languages (e.g., C, C++, and the JAVA programming language, possibly employing the JAVA Native Interface) support functionality suitable for implementing the invention.

At 402, an image representing at least a portion of the three-dimensional space is displayed. Although the image may have only two dimensions, a third dimension is implicit (e.g., due to the focus position of an automated microscope when the image was captured). In some cases, the entire image is not displayed, but only a portion of interest is shown. It may be desirable to scroll within the image or zoom (e.g., in or out) to better concentrate on a region of interest within the three-dimensional space.

At 404, the method receives an indication of a point on the image. For example, such an indication can take the form of an operator clicking on a portion of the image at a particular location at which the operator desires to position an item.

At 406, responsive to receiving the indication of 404, the method transforms the point on the portion of the image into a three-dimensional location within the space. Such a result can be achieved, for example, by using the focus position of a microscope in conjunction with the X and Y coordinates of the position specified in 404. A variety of transformations can be used, perhaps in series, to determine the appropriate three-dimensional location and the three-dimensional positional information (e.g., values) to be sent to a controller for positioning the item.

At 408, the item is moved to the three-dimensional location in the space. For example, appropriate directives can be sent to the micromanipulator controller 132 of FIG. 1. In some cases, the micromanipulator may implement a non-orthogonal coordinate system. For example, the x-axis may be declined to be parallel to whatever is holding the item (e.g., the item's holder connects the item to the micromanipulator). The transformation can be configured to account for such an arrangement.

### Exemplary Overview of Transformations

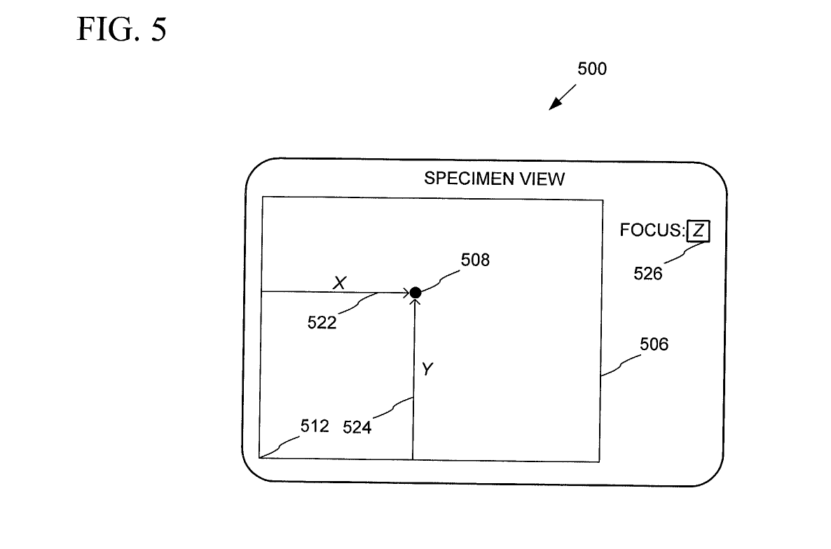

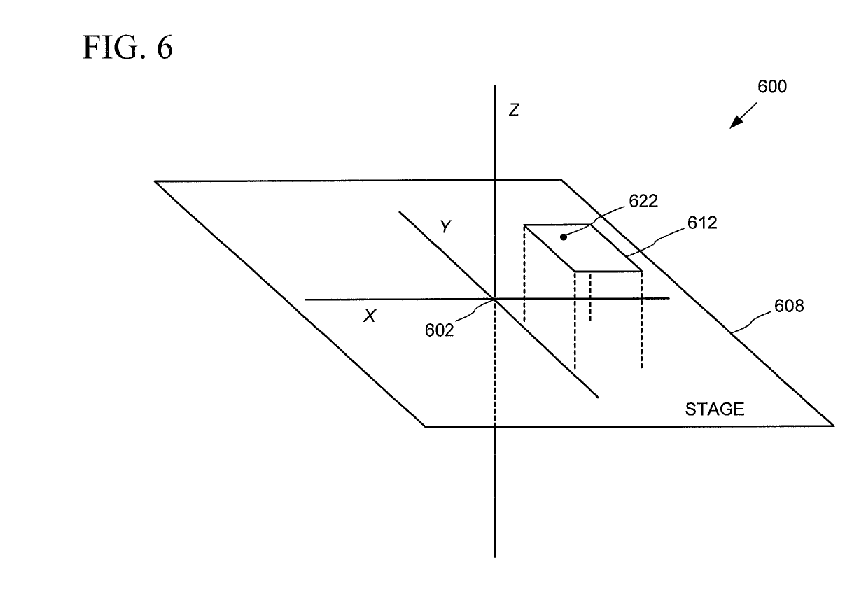

FIGS. 5 and 6 illustrate an exemplary transformation from one coordinate system to another. FIG. 5 shows a coordinate system used with a user interface 500, which includes an image portion 506 showing a two-dimensional representation (e.g., an optical slice) of a specimen.

In the example, the coordinate system is sometimes called the “pixel” coordinate system. The location 512 is designated as the coordinate system origin and is effectively assigned the value (0, 0) in an X, Y coordinate system. The point 508 on the image portion 506 can be represented by an X portion 522 and a Y portion 524. These portions can take numerical (e.g., integer) values according to the number of pixels from the coordinate system origin 512. In the example, a focus position 526 of a microscope is displayed and represents a Z component of the coordinate system. The value can take a numerical (e.g., integer or floating point) value as is appropriate for the system (e.g., in accordance with the microscope focus controller 112 of FIG. 1).

The point 508 can thus be represented by a numerical triple: X, Y, Z. FIG. 6. shows another coordinate system 600 having a point 622 corresponding to point 508 of FIG. 5. The coordinate system 600 has a coordinate system origin 602 and X-, Y-, and Z-axes, which are designated with reference to a plane parallel to the microscope stage 608. The region 612, which is illustrated as somewhat elevated from the stage 608, corresponds to the image portion 506 of FIG. 5. The illustration of FIG. 6 is not meant to be to scale.

Further transformations, or other, intermediate, transformations may be appropriate so that the proper directives can be sent to controllers that position an item on the specimen at the desired indicated location. In some cases, it may be advantageous to define a point corresponding to the location of a moveable item as the origin.

### Exemplary Implementation of Transformations via Matrices

One implementation uses a set of matrices to transform a selected location on a displayed image representing a specimen into a coordinate system specifying a physical location within the specimen. The physical location can then be converted into a coordinate system specifying a motor position of a motorized manipulator. The motor position can then be sent to a motorized manipulator operable to move the item to the location within the three-dimensional space (e.g., within the specimen).

For example, if the location of a point in the coordinate system of FIG. 5 is designated as vector A composed of the X, Y, and Z coordinates of the point, and the location of a point in the coordinate system of FIG. 6 is designated as vector B composed of the X′, Y′, and Z′ coordinates of the point, a matrix T can be used to transform vector A into vector B as follows:

B=TA (1)

To account for the possibility that the two coordinate systems may not have the same coordinate system origin, a variety of techniques can be used to translate the origin. For example, a constant vector c can be added as follows

B=TA+c (2)

Alternatively, a technique employing homogeneous matrices can be used. For example, a 4×4 homogeneous matrix could have the bottom row of the matrix set equal to zero, except that the value T_{4,4} can be set to an arbitrary value (e.g., 1). To work in conjunction with the homogeneous matrix, the vectors A and B can include a fourth component, typically a constant k, which can have an arbitrary value (e.g., 1). The transformation, including the translation then takes the form

B=TA (3)

To determine appropriate values for Tin any of the techniques, a calibration technique can be used, as described in more detail below.

When the field of view moves (e.g., by moving the microscope), some values of the matrices can be changed. For example, a new displacement (e.g., origin offset) may be calculated.

Exemplary Calibration

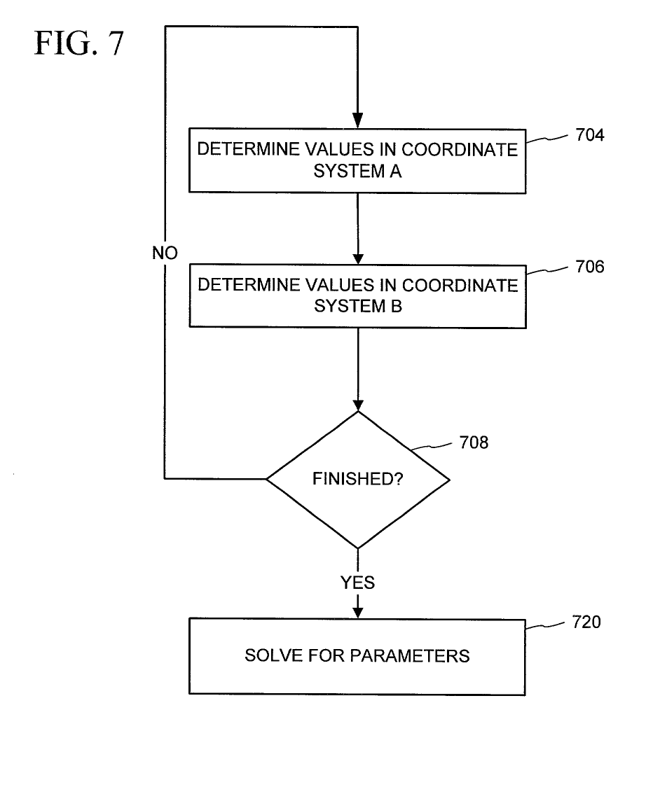

Calibration can be used to set appropriate parameters of the system. An exemplary method for calibration is shown in FIG. 7. At 704, the method determines values for a point in a first coordinate system. For example, x, y, and z values are determined. In the example of a two-dimensional image representing a specimen viewed under a microscope, the x and y values are taken from a click on the item or probe tip, and the z value is implicit: the focus position of the microscope when the image was captured (e.g., the current focus location).

Then, at 706, the method determines values for the same point in a second coordinate system. For example, x, y, and z values are determined. In the example of a probe, the x, y, and z values can be read from the probe's controller.

At 708, it is determined whether the collection of points is finished. If not, more data is acquired at 704. Otherwise, the method solves for parameters at 720. Typically, a number of points are collected and saved; then the parameters are solved using the set of points. Each point can also be described as a pair of points (six values total), the pair representing the same point in two different coordinate systems.

An example of solving for parameters is to solve for the matrix T as shown in Equation 3. If the matrix is a 4×4 homogeneous matrix, solving for the matrix (e.g., ignoring the bottom row) involves three mathematically independent equations having four variables each. So, a minimum of 4 pairs of points (e.g., each point having 3 values: x, y, and z) should be collected to solve for the matrix. A linear least squares procedure can be used to fit the sample points, from which the matrix is constructed.

### Exemplary Implementation Using Plural Matrices and a Plurality of Mathematical Spaces

In some scenarios, it is advantageous to employ other matrices in place of or in addition to the single matrix technique described above. For example, a variety of mathematical spaces (e.g., coordinate systems) can be defined for a variety of purposes and a matrix transform can be used to express a point in any of the spaces. In such a case, a set of intermediary matrices could be used in place of, or in conjunction with, the single matrix technique described above.

Such an approach has the advantage of consistency because a transform between spaces is achieved in the same way (e.g., via a homogeneous matrix). Although other approaches can be used (e.g., a custom transformation operation or set of functions), using a matrix leads to more efficient and easier to understand logic. Another advantage is that the matrices for the transforms can be examined to determine characteristics of the system that would not otherwise be immediately evident.

Calibration can be achieved incrementally. For example, some calibration results can be reused so that changes in the system do not require full calibration. For example, when an objective is changed, information gathered from one space for another objective might be useful to avoid having to recalibrate the entire system. Also, incremental calibration can result in more accurate calibration. For example, certain elements of the calibration can better be extracted at low objective magnification, while others are better extracted at high objective magnification.

In certain scenarios relating to microscopes, various assumptions about the system can be made. For example, assumptions can include that the microscope's stage has a plane perpendicular to the optical axis of the microscope; that the item manipulator has three axes: drive (or x), y, and z, where the z axis is perpendicular to the plane of the stage; the item manipulator's y axis is be perpendicular to the z axis (and attached to the z-axis drive) and is therefore co-planar with the microscope stage; the manipulator's drive axis is attached to the y-axis drive; and the drive axis is declined relative to a perpendicular to both the y and z axis.

In light of the above assumptions, six coordinate systems defining six spaces are shown in the following example:

TABLE 1
Spaces

| System | Symbol | Units | Description |
|---|---|---|---|
| controller | c | μm or | Incorporates micromanipulator x, y, and |
| | | motor | z; may flip axis sign if convenient (e.g., |
| | | units | depending on position of micro- |
| | | | manipulator) may be declined (i.e., non- |
| | | | orthogonal) or not, depending on micro- |
| | | | manipulator hardware |
| manipulator | m | μm | Similar to controller system except |
| | | | x-axis is declined parallel to axis of the |
| | | | probe (e.g., non-orthogonal coordinate |
| | | | system) |
| reference | r | μm | x, y, z (e.g., orthogonal coordinate |
| | | | system); declination angle removed |
| stage | s | μm | rotated to be aligned with image space, |
| | | | but has same origin as item being |
| | | | moved |
| image | i | μm | scaled with respect to pixel coordinate |
| | | | system but shares origin with pixel |
| | | | coordinate system |
| pixel | p | none | selected point of on screen image and |
| | | | three-dimensional data (e.g., focus |
| | | | controller position) |

In the example, all six systems represent the same three-dimensional space, and the location of any item (e.g., the tip of an electrode) can be represented in each system. Using the transformations, the same point can be represented via different perspectives. Even though the point is the same, the values used to represent the point in the different systems may be different. A point in pixel space may be transformed to an equivalent point in controller space to position an item at the physical location corresponding to a selected point in pixel space.

Transformations between the spaces can be achieved via homogeneous matrices as described above. For example, if the vectors P and M are points in spaces p and m, respectively, (e.g., each vector representing the same location of an item viewed under a microscope) a matrix Tₘₚ can be used to map one vector to another as follows:

P=TₘₚM (4)

Similarly, a transformation from space c to space p can be achieved by

P=T_{cp}C (5)

where P is a point in space p, and C is the same point in space c.

The transform T_{cp} is sometimes called the “total transform” because it provides a transform from controller space into pixel space (i.e., the total transform needed to transform across the listed spaces). In some systems, it might be advantageous to define Tₘₚ as the total transform, and T_{cm} can be configured via the software.

Based on these assumptions, a set of matrices can be computed to transform a vector in one of the spaces into another space as follows:

TABLE 2
Transformations

| Transformation | Dependency | Computed From |
|---|---|---|
| T_{cm} | item | signs of axes as set in configuration of |
| | | controller; can also be set to decline x |
| | | axis for orthogonal manipulators |
| Tₘᵣ | item | values for removing declination angle |
| | | theta |
| Tᵣₛ | item | values for removing rotational angle |
| | | phi, (e.g., clockwise from left) |
| Tₛᵢ | item and | values for tying the origin of an item |
| | objective | to the image by focusing and clicking |
| | | on image of item |
| Tᵢₚ | objective | values to scale to dimensions of a |
| | | pixel and units of focus controller |

The right- or left-handedness of the coordinate systems is assumed consistent. To accomplish consistency, signs can be toggled via a software configuration feature. For example, a setting called “controller sign” can be set for a controller. The controller sign is typically a low level sign change that is implemented in a controller driver. An advantage to having a controller sign setting is that a manipulator can be placed on either the left or right side of a microscope and still have a positive y go in the same perceived direction (e.g., down on an image representing a view of a specimen).

If the resulting direction of each axis corrected by controller sign still does not form a consistently right- or left-handed system, a setting “positioning sign” can be set. Typically, the positioning sign setting is extracted during calibration. However, some calibration procedures may assume the sign has already been extracted. Factors affecting the positioning sign include the side of the stage on which a manipulator is mounted, inversion of the optical path, rotation of the camera body, and whether a normal or inverted microscope is being used.

The user need not be concerned with the details of the handedness of the coordinate system. If the signs are wrong, the item will move in the opposite direction from what is expected. The user can then toggle the sign to produce expected behavior (e.g., when clicking on a point in an image to automatically move an item).

As shown in the above example, at least one of the spaces defines a non-orthogonal coordinate system. Such a definition is advantageous because many manipulators provide three axes: drive (or x), y, and z. On most controllers sampled, the drive axis is declined. Some controllers (e.g., Sutter Instrument Company's MP-285) arrange the axis orthogonally.

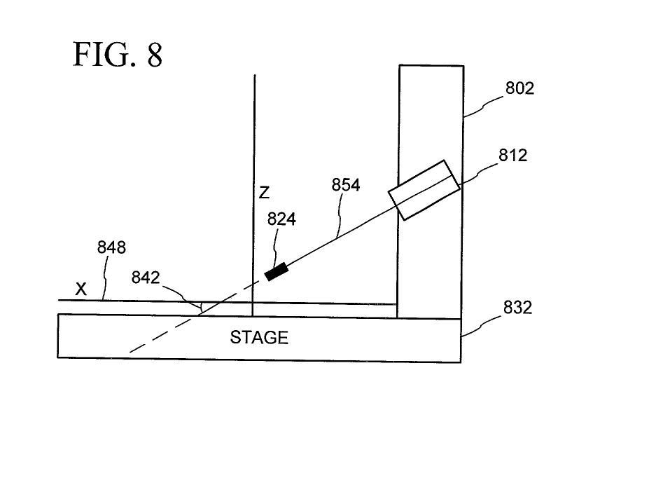

For example, as shown in the block diagram of FIG. 8, a manipulator 802 having a motor 812 is used to manipulate a moveable item 824 as it is being viewed on a microscope having a stage 832. The angle phi 842 is the angle of declination between a reference x axis 848 (which is assumed to be parallel to the microscope stage 832) and the drive axis (or “motor axis”) 854. The angle is typically somewhere near (e.g., between) 20-25 degrees.

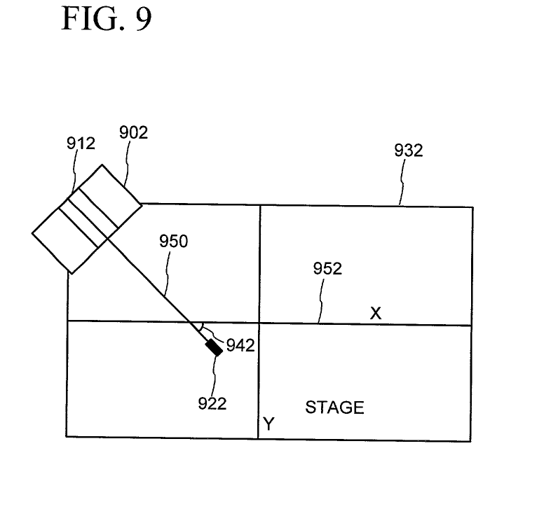

An additional angle involved in the model is phi, which is defined as the rotation of the motor axis about the z-axis. For example, as shown in the block diagram of FIG. 9, a manipulator 902 has a motor 912 for manipulating the item 922 and is positioned on a microscope stage 932. A rotational angle phi 942 is defined with respect to the drive axis 950 and a reference x axis 952, parallel to the x-axis in the image coordinate system. In the example, a manipulator placed on the left part of the image is considered to have a phi of 0.

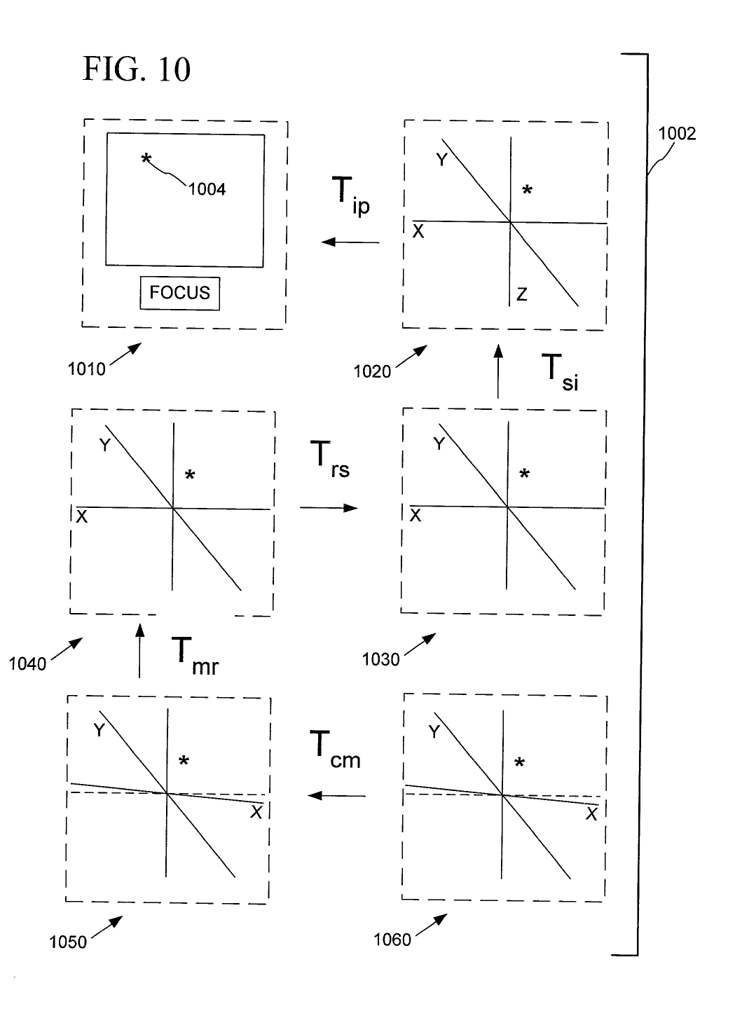

The various transforms effectively make the manipulator coordinates orthogonal, rotate them to be aligned with image axes, translate to tie the item (e.g., a point on the item, such as its tip) to a pixel in a displayed image, and scale them to match the screen image and focus controller. FIG. 10 shows the set 1002 of spaces p 1010, i 1020, s 1030, r 1040, m 1050, and c 1060 and appropriate associated transforms. A same point 1004 can be specified in any of the spaces. Transforms in the other direction can be achieved by taking the inverse of a matrix.

Calibration of a system using the above matrices includes taking a sample of points and then calculating Tₘₚ. From Tₘₚ, scale, displacement, phi, theta, and positioning sign can be extracted (e.g., in that order). These parameters can be used to construct the other matrices, which are used to transform points from one space into another. These parameters can then be presented to the user, who can modify them directly.

In one embodiment, movement of an item is achieved by specifying where the item is (e.g., by focusing on it and then clicking on it) and then specifying where the item is to be located (e.g., by focusing a microscope and clicking on a location within a displayed image). When the current location of the item is specified, an origin is defined as the current location. Then, from the origin, the desired location is calculated, and directives are sent to the manipulator controller to position the item at the desired location.

However, the assumptions of the model are not always strictly correct. Therefore, a transformation through the series of intermediary matrices computed as described above may not result in exactly the same vector as a transform through a total transform matrix. In other words, the transform Tₘₚ might not equal the transform defined by the chain of derived matrices Tᵢₚ Tₛᵢ Tᵣₛ Tₘᵣ.

To account for errors in the assumptions of the coordinate system model and errors associated with calibration, a residual transformation matrix Tᵣₑₛ can be computed as follows:

TABLE 3
Error Matrix

| Transformation | Dependency | computed from |
|---|---|---|
| Tᵣₑₛ | item and | solving for the matrix that will transform |
| | objective | the result achieved from the intermediary |
| | | matrices into that achieved with the total |
| | | transform matrix (e.g., Tₘₚ) |

Tᵣₑₛ can be calculated from calibration data, from intermediary matrices (e.g., Tᵢₚ Tᵢ Tₛᵢ Tᵣₛ Tₘᵣ), or from parameters (e.g., alpha, phi, displacement, positioning sign) via the intermediary matrices. The residual transformation (or “error”) matrix can be incorporated into the transformation (e.g., as part of the chain Tᵢₚ Tₛᵢ Tᵣₛ Tₘᵣ) or simply ignored during the transformations but provided for evaluation to determine how well the system is calibrated.

In one method, Tres is initially set to the total transform matrix. Then, parameters (e.g., scaling factor, theta, and phi) are sequentially extracted and mathematically removed. As each parameter is extracted, Tᵣₑₛ should approach the unity matrix.

If the system is properly calibrated, the residual transformation matrix Tᵣₑₛ should approximate the unity matrix and contain only minor corrections. Problems with the system can be diagnosed by examining Tᵣₑₛ. For example, if there are negative diagonal terms, sign parameters may need to be inverted via a software configuration option. If the off diagonal terms are very different from zero, assumptions of the model described above may be wrong. For example, non-zero off diagonal terms can be caused if the axes assumed to be orthogonal are not orthogonal. If the diagonal terms are very different from one, the scale factor may need to be adjusted via a software configuration option or further calibration. If two columns are switched, the axes may be switched (e.g., y is mapped to x and vice versa).

Another cause of non-zero diagonal terms might be that the manipulator y-axis is not parallel to the image plane of the microscope. Still another cause might be that the z-axis is not parallel to the optical axis of the microscope. Such problems can be solved by modifying the microscope stage.

Assuming the physical system conforms to the model, errors in Tᵣₑₛ are typically small; their causes can include a variety of circumstances. For example, manipulator lash may be significant under high objective magnification. To solve such a problem, a jog parameter can be increased via a software configuration option, and automatic calibration sequencing can be used.

Yet another cause of error might be that there is significant optical distortion as might be caused when looking through an air/water interface. Such a problem can be solved by using a water immersion lens, using a slice or cover slip to make sure the air/water interface is optically flat, or otherwise flattening out the optical path. The mathematical operations can avoid error related to refraction (i.e., it is similar to magnification) if the air/water interface is optically flat.

Since the last operation during calibration typically involves specifying the location of the moveable item, the system additionally knows the location of the moveable item and is ready to move it to a location specified by clicking on the image representing the specimen.

Inverses of the various matrices can be taken as needed to convert from a point in pixel space p to manipulator space m as follows:

M=Tₘₚ⁻¹P (6)

Thus, for example, a selected point on an image can be transformed into the appropriate point in manipulator space so that the proper directives can be sent to the manipulator to position an item at a location corresponding to the selected location.

Some manipulators (e.g., micromanipulators available from Sutter Instrument Company of Novato, Calif.) have an orthogonal coordinate system (i.e., their motor axes are organized at right angles instead of having an x-axis declined relative to the z-axis). The above example using a transformation into the non-orthogonal space m will still accommodate such a manipulator. However, it may be difficult to determine the declination angle via automatic calibration. For example, it may be helpful to measure the angle with a protractor and enter it manually as a parameter theta. In addition, some calculations are slightly different.

In some cases, a two-point measurement of the angle can be done. However, due to bending of electrodes, such an approach is typically not accurate.

Positioning is still done by mapping from pixel to manipulator coordinates

M=TₚₘP (7)

Manipulator coordinates are then mapped to reference coordinates:

R=TₘᵣM (8)

Controller coordinates are defined relative to reference coordinates:

C=T_{rc}R (9)

When using non-orthogonal manipulators with a declined drive axis, the current location of the controller is read by the transformation

T_{cm}=T_{cm}⁻¹ (10)

which simply changes the sign of the controller as follows:

M=T_{cm}C (11)

In orthogonal manipulators, the transformation is similar except that T_{cm} is defined to change sign and then map to manipulator coordinates:

T_{cm}=TᵣₘT_{cr} (12)

### Safe Level

During micromanipulation operations, the operator may wish to reposition an item. However, if the item is positioned inside (e.g., beneath the surface of) a biological specimen, moving the item directly from one location to another may result in considerable damage to the specimen.

To avoid such damage, the system can support definition of a safe level. For example, a certain distance above a microscope stage can be defined as safe, above which movement of a manipulated item will not cause damage to the specimen. Then, upon activation of a feature (or automatically in some cases), the system can retract the item to the safe level. The item can then be moved freely without regard to damaging the specimen. Typically, the safe level is defined by an operator, who can determine the appropriate distance from a specimen surface at which movement is safe, based on the texture of the specimen. Thus, a safe zone is defined as the zone within which an item can be moved without damage to the specimen. Typically, the safe level is defined as a plane (e.g., a level of focus); points above the plane are considered to be in the safe zone.

The safe level can be used for a variety of purposes. For example, when an item is moved from one location to another, it can be automatically retracted to a safe level before it is reinserted into the specimen.

The point along the manipulator's x-axis that is safe can be determined by finding the difference between the safe level and the z component of the current location of the item (in the reference system). The difference divided by the sine of the declination angle theta gives the distance of travel. Thus, to determine a safe point when movement is along the x-axis:

R=TₘᵣM (13)

Mₓ_{_{—}}_{safe}=Mₓ+(Z_{safe}−R_{z})/ sin(Theta) (14)

M_{y}_{_{—}}_{safe}=M_{y} (15)

M_{z}_{_{—}}_{safe}=M_{z} (16)

where M_{z}_{_{—}}_{safe} is the z component of the manipulator's safe point. Z_{safe} is the safe level given by the focus controller translated from the pixel to the reference coordinate system. R_{z} is the axis position in reference coordinates.

If movement is along the z-axis, then the formula for the safe point is:

Mₓ_{_{—}}_{safe}=Mₓ (17)

M_{y}_{_{—}}_{safe}=M_{y} (18)

M_{z}_{_{—}}_{safe}=(Z_{safe}−R_{z}) (19)

### Error Correction Mechanisms

Successful calibration of the system can depend on correcting various errors related to lash, cross lash, drift, spherical aberration, the specimen, and digitization linearity. The system can be configured to avoid some of these errors.

Lash is caused when a manipulator moves along one axis and then reverses direction. The actual position of the manipulator lags behind the motor position due to mechanical slack. A lash setting is provided for each axis of each manipulator. The amount of lash for a manipulator can be determined by the simple test of moving the manipulator a small distance in one direction and then the opposite direction. Then, the motor distance that corresponds with zero actual displacement is the lash. Typically, lash should be defined before doing a calibration.

When a manipulator movement in one axis causes a movement in another axis, cross lash results. Cross lash is typically caused by rotation of a worm drive, which causes a rotation of the manipulator mechanism. Cross lash shows up as a displacement because of the long working distance from the manipulator itself and the item being manipulated relative to the working dimensions. Careful servicing of the manipulator typically avoids cross lash. Monitoring for cross lash is advised.

A lash measurement can be taken by performing short movements in each axis (e.g., moving focus or a manipulator) and returning to the starting point. Such a measurement can be taken in one direction and then the opposite direction. Then, the operator can record the error. Typically, measurements are taken under high objective magnification.

Some microscope control motors are coupled to the microscope focus drive by a friction clutch. An optical encoder, if present, is usually attached to the motor, not the microscope. The clutch, coupled with the weight of the microscope leads to distance dependent drift. A drift correction can sometimes correct the linear component of drift. However, a direct coupled focus controller eliminates drift. Typically, a drift correction, if any, is defined before doing a calibration.

A drift measurement can be determined by long movements in the z-axis (e.g., moving focus or a manipulator) and returning to the starting point. The operator can then record error. Typically, drift is measured under high objective magnification.

Lenses have some amount of spherical aberration. In the illustrated systems, the size of the aberration is small and can be ignored. However, some systems may have aberration in objectives and intermediate lenses, if any. Monitoring for spherical aberration is advised. Spherical aberration can be measured by inspecting an image of the edges of a microscope slide or by noting the position of a fixed point on a slide while the field of view (e.g. motorized platform or stage) is moved a known amount.

In some cases, the specimen itself can cause error. For example, if an electrode is being located within tissue, the tissue can cause the electrode to bend considerably. By resetting the origin frequently, some of the error can be avoided.

Typical RS-170 cameras convert a signal from CCD chips to analog signals. Digitizers convert an analog RS-170 signal to a sequence of integers. Some cameras (e.g., Vidicon or Nuvicon cameras) may have poor digitization linearity. Confirming linearity specifications of the camera and digitizer is advised, but error is usually negligible.

Once at least one of the matrices has been defined, a calibration report can be provided to indicate how well the system has been calibrated. An exemplary calibration report lists the number of points used in a calibration. Also RMS error for each axis (x, y, and z) can be included. RMS error is defined as the square root of the average of the differences between manipulator and image points as expressed in manipulator coordinates. For each calibration point, the image point (in pixel coordinates) is composed of an image click point and a value from the microscope focus controller. The image point is mapped from pixel coordinates to manipulator coordinates. Then the difference of the manipulator and image point is taken, squared, summed, and then the square root is taken. RMS error indicates typical error during positioning due to calibration. RMS for j points is defined as

$$RMS = \sqrt{{\sum }_{j} {( {p}_{j} - {T}_{pm} {p}_{j} )}^{2}} \qquad ( 20 )$$

A worst error can also be provided. Worst error is computed in the same way as RMS, except that the maximums of the absolute differences are reported. Worst error indicates the worst case positioning error due to calibration.

An error recording feature can be enabled via a menu option. During error recording, sample points from a calibration operation are saved in a table. The values, expressed in reference coordinates, can be exported. Three sets of three columns can be provided. The first set gives the manipulator point in reference coordinates. The second set gives the pixel/focus point in reference coordinates. The third set gives the manipulator point minus the pixel/focus coordinates in reference coordinates. Differences can be represented as a percentage (e.g., 2*[mx−px]/[mx+px]). Table 4 shows an exemplary table built during error recording, which can be exported for further analysis.

TABLE 4
Error Recording

| mx | my | mz | px | py | fz | ex | ey | ez |
|---|---|---|---|---|---|---|---|---|
| −23.49 | −22.00 | −40.55 | −26.77 | −24.75 | −40.91 | 3.28 | 2.75 | 0.36 |
| −23.49 | −22.00 | −40.55 | −29.67 | −18.15 | −40.94 | 6.18 | −3.85 | 0.39 |
| −23.49 | −22.00 | −40.55 | −25.70 | −16.42 | −40.90 | 2.21 | −5.58 | 0.36 |
| −23.49 | −22.00 | −40.55 | −22.92 | −14.48 | −40.88 | −0.57 | −7.52 | 0.33 |

Error Table 09/09/99 09:09:09
Values expressed in reference coordinates.
m = manipulator, p = pixel, f = focus, e = difference

### Exemplary Implementation of Calibration

Various methods can be used to calibrate the system. The following describes a system that employs an incremental calibration that leads to accurate positioning of an item. The system includes initial calibration, comprehensive calibration, focus calibration, electrode plus objective calibration, electrode calibration, objective calibration, and objective alignment. An automatic calibration process is also supported.

Initial Calibration

Initial calibration is helpful to establish basic parameters for the system. Initial calibration can include entering theta (the angle of manipulator axis declination) and phi (angle of rotation about the z-axis) and the power of the objective, which can be defined using a name that includes an integer (e.g., “x50”) for the sake of convenience. Once the parameters are entered and the objective is named, a menu item can be selected to activate initial calibration, which includes estimating a scale parameter based on a representative microscope.

The initial calibration can be tested by moving an item a small distance from the origin, including some movement in the z direction. If the item moves in the opposite direction expected, then the positioning sign setting can be inverted. If the item moves less of a distance than expected, the value of the scale parameter can be decreased. Scale can depend, for example, on the size of a CCD chip and optics of a particular microscope.

Other forms of calibration can be achieved via a calibration tool, which provides a dialog box to guide the operator through the selected calibration process. Some of the calibrations depend on others to work properly. Once the system is calibrated, certain changes require only partial calibration, as shown in Table 5.

TABLE 5
Recalibration

| Change to system | Electrode recalibration | Objective recalibration |
|---|---|---|
| manipulator hardware | yes | no |
| replace objective (even if | no | yes |
| same specification) | | |
| rotate camera | yes, phi | yes, scale |
| change declination angle | yes, theta | no |
| optical path | yes, phi | yes, scale |

Typically, focus calibration needs only be performed once. In the example, the microscope platform controller or stage controller is not calibrated.

The calibration process involves moving the item (e.g., the tip of an electrode) to a point, carefully focusing the microscope on a particular item (e.g., the tip of an electrode) and then clicking on the item. Then, the item is moved to another point, and the process is repeated. After a satisfactory number of points have been selected, an indication is made to the system, which then performs the appropriate calculations based on the selected points.

Collection of data for a point involves collecting data from two coordinate systems: the image coordinate system (x, y, and focus <z>) and the manipulator coordinate system (drive <x>, y, and z). The image coordinate system data comes from the x, y coordinate of the image location that is clicked and the focus controller. The manipulator coordinate system data comes from querying the manipulator controller. The data for the points can then be used to calculate parameters for use during positioning of an item.

Comprehensive Calibration

Comprehensive calibration (sometimes called “3D transformation”) is used to determine a rough z-scale, electrode parameters (positioning sign, theta, and phi), and objective parameters (x scale and y scale). It also affects the residual matrix. Comprehensive calibration typically requires at least 4 points. Typically, 8 points are taken roughly at the comers of a imaginary cube. Calibration is more evenly weighted calibration with some multiple of 8 points. This calibration can be used for the first positionable item and objective.

Focus Calibration

Focus calibration is typically a two-point calibration that determines the z-scale parameter. A high power objective (e.g., with a narrow depth of field) and two points in widely different focal planes are recommended for greater accuracy. Any multiple of two points can be used. This calibration is helpful because it refines the z-scale parameter estimated by comprehensive calibration. A good estimate of the declination angle theta depends on accurate focus calibration.

Electrode plus Objective Calibration

Electrode plus objective calibration determines electrode parameters (positioning sign, theta, and phi) and objective parameters (x scale and y scale). A multiple of four points is used.

It is convenient to use electrode plus objective calibration if neither the electrode or the objective have been calibrated and the z-scale parameter (focus) can be assumed to be correct. Low or medium power and four or more points roughly on the comers of a square are recommended to maintain accuracy. Theta is estimated, so proper calibration depends on accurate focus calibration.

Electrode Calibration

Electrode calibration determines electrode parameters (positioning sign, theta, and phi). Low power only to avoid lash and moving only the x and z axis of the item is recommended. This calibration can be used if there is already good objective and focus calibration. It is convenient to use electrode calibration on successive electrodes (e.g., second, third, fourth) after the first has been calibrated with electrode and objective calibration. The computation of phi depends on objective calibration, and declination angle theta depends on focus calibration.

Objective Calibration

Objective calibration determines x scale and y scale. Objective calibration is appropriate if electrode calibration has already been done. This calibration can be used if there is already good electrode and focus calibration. Some multiple of four points lying roughly on the comers of a imaginary square are recommended.

Objective Alignment

Objective alignment assists a feature for estimating the origin (e.g., location of an item) after switching to a higher power objective. Such a feature can be helpful when trying to position the item in the field of view. An origin estimate is taken from the next lower power objective.

Objective alignment can be achieved by going from the highest to lowest power objective, viewing the same object (e.g., a mark on a slice), and clicking on it. Only the focus controller should be adjusted during this calibration operation.

The calibration tools support adding additional points to a calibration after calculations have been done. Such a feature can be useful, for example, when an insufficient number of points have been added during a calibration process. Some errors (e.g., lash) are decreased by using a low power objective during the calibration process.

Automatic Calibration

An automatic sequencing of points feature can be selected for any of the calibration methods. The system then automatically moves to a sequence of points to simplify the calibration process. The feature draws a frame in the center of a displayed image and requests the item be placed in the center of the frame. The system (e.g., as determined by software) then sequences through 2, 4, or 8 points as appropriate for the calibration method. To minimize the effect of lash, the feature jogs (e.g., goes away in a fixed direction and then returns to) the item by the amount (e.g., a distance) indicated in a jog parameter. Such an approach avoids the effects of lash if the jog distance is larger than the lash.

At the end of the sequence, the system returns to the first point and repeats. Calibration can be ended at any time, but typically is ended at the end of a sequence. A large number (e.g., 50) points can be collected. If a special key (e.g., the option key) is held down while clicking on the last point, the item will not move to the next sequence point.

Further Calibration Details

A calibration report as described above can assist in determining whether calibration was successful. If only four points were selected, RMS and worst error will be zero, but calibration may not be accurate. Incremental calibrations (e.g., electrode plus objective, objective, or electrode) will duplicate or quadruple calibration points by expanding in x, y, or z in such a way that some parameters are pre-determined when a matrix is computed by solving the linear equations.

Residual Matrix

The residual matrix need not be used in computations and can be provided for review by the operator as a diagnostic tool. For example, the matrix indicates how well the system conforms to assumptions about the model used to estimate the system. Accordingly, the residual matrix may be recomputed after incremental calibration operations to indicate how well transformations are working in light of the calibration. In some cases, the residual matrix is calculated to particularly indicate the results of a particular calibration operation (e.g., only the most recent calibration). Therefore, certain incremental calibrations may arbitrarily hold certain parameters constant to better highlight errors peculiar to the calibration being performed. In this way, the residual matrix varies in its accuracy of reporting how well the overall transformations are working.

Accordingly, the user may evaluate the residual matrix to make manual adjustments to parameters such as angles and scale factors. The user may then choose to discard results of the matrix (e.g., set the residual matrix to the unity matrix) and rely on the manual adjustments.

However, the residual matrix could also be used to adjust the results obtained by using the other transformation matrices. Such an approach can be advantageous because error detected by the comprehensive transformation is propagated to other models. In such a case, it is important that an accurate comprehensive transformation be done. In some cases, the residual matrix can adversely affect accuracy because the incremental matrix might represent errors that are adjusted out via incremental calibrations.

### Exemplary Features

A variety of features can be presented to assist in positioning an item at a location within a three-dimensional space. In one implementation described below, these features include an origin tool, an origin estimation feature, a new item tool, a toggle items tool, a set safe level tool, a positioning tool, and focus movement. Features related to the field of view include field of view movement, way points, moving to the current item, and moving an item to the current location.

Origin Tool

Before the operator can select a location on a displayed image at which an item is to be positioned, the item is tied to the image. The item can be tied to the image during calibration or by performing an origin operation. This operation is sometimes called “setting the origin.” Setting the origin is akin to instructing the software that the item (e.g., the tip of an electrode) is in focus and is located at a location indicated (e.g., by clicking the mouse on the item in a graphical representation of it). Thus, the proper focus setting can be manually selected to place the item in sharp focus before setting the origin.

In one implementation, the origin operation is achieved by selecting an origin tool and simply clicking on the item in the image while the origin tool is selected. Once the origin is set, a graphical cross appears on the image to show where in origin was set.

Because such an operation may be performed routinely after an item is positioned, an option is provided to automatically toggle between performing an origin operation and positioning the item. Thus an operator can tie the item to the image by performing the origin operation (e.g., by clicking on the item as shown in the image), select a position at which the item is to be placed, then again perform an origin operation (perhaps on a second item), select another position at which the item (or second item) is to be placed, and so forth, without having to separately select an origin tool. In this way, after receiving an indication of a location within the graphical representation where the item appears (e.g., setting the origin), the next indication of a location within the graphical representation is automatically interpreted as a directive for positioning the item at a three-dimensional location corresponding to the location indicated

Origin Estimation

When switching from a low power to a high power objective, the field of view is significantly reduced. So, after such a switch, an item may be out of the field of view, and it is sometimes difficult to find the item. Based on calculations performed during the align objectives feature described above, the origin estimation feature estimates the origin (e.g., the location of the item) in the coordinate system relating to the new objective. Origin estimation uses the next lower power objective's origin as a basis for estimating the origin for the current objective.

Origin estimation can be achieved by pressing a special key (e.g., the option key) and selecting the origin tool. The origin is then estimated, and the system automatically switches to the positioning tool. The operator can then click on the image to select a location and position the item at the selected location.

New Item

To add a new item (e.g., placing an item on a manipulator), the item is fully retracted via a new item button. After the new item is attached to the manipulator, it can be manually driven into view on the image. Once the item is in view and properly focused, the origin tool can be used to tie the item to the image.

Toggle Items

To change objectives, it is often desirable to move obstructing items. A toggle items feature moves all items a distance along the x axis, then a distance along the y axis as specified in a software configuration option. The objective can then be changed. The operator can then re-select the toggle items tool to move the items back to their original locations

Set Safe Level Tool

To set a safe level, first a surface level is set by moving the focus to a plane at or just outside the specimen being viewed. Then, a “distance from surface to safe level” setting can be configured via software to indicate a proper safe level.

In some cases, manually moving the focus requires resetting the surface level, although some focus controllers can detect manual movements via rotary encoding.

Positioning

Once calibration is completed, the item is tied to the image, and a safe level has been established, an item can be positioned at a location on the specimen corresponding to a location selected on an image representing the specimen.

One positioning feature can automatically retract an item to the safe level before seeking a new location if the item is below the safe level. Such a feature is useful, for example, to avoid damage to tissue being viewed under a microscope.

To position the item, the operator selects a positioning tool (unless automatically selected as described above), adjusts the focus to focus on the desired location, and clicks on a displayed image representing the specimen at a desired location with a mouse pointer. The system then positions the item at a location in the specimen corresponding to the location selected on the image.

Configuration options can be selected to provide for an approach into the item via the x or z axis, and whether the final approach should be continuous, to the surface, or sultatory (i.e., move then pause).

Focus Movement

In addition to manual focus, a feature can provide for adjusting the focus. For example, pressing the arrow keys on a keyboard can move the focus up and down.

Field of View Movement

Field of view movement can be accomplished by moving the microscope platform about a fixed stage or moving the stage about a fixed microscope. Field of view movement can be achieved manually (e.g., via a stage joystick). In some scenarios, manual movement can be enabled/disabled via an Enable Stage checkbox.

Field of view movement can also be achieved via arrow keys on the system's computer keyboard. In one embodiment, the field of view can be moved by holding down a special key (e.g., the option key) and pressing an appropriate arrow key. The step size of such movements can also be adjusted. For example, special keys (option-[and option-]) can be designated for increasing and decreasing the step size, and a software configuration option is provided for manually setting an arbitrary step size.

Sometimes field of view movement can result in moving an item out of the field of view. Finding the item may be difficult. The origin (i.e., current location) of an item is typically invalidated when the field of view is moved, so protection is put in place to prevent using it. However, it is possible to override such protection if, for example, an item cannot be found.

Way Points

Way points are provided to remember field of view locations. The current location of the field of view can be saved as a way point, and then the operator can conveniently return to the way point. An exemplary way of implementing way points is to present a user interface element (e.g., a box) for each way point. The user interface element can then indicate if the way point is disabled, enabled, or current via a visual indication (e.g., white, black <inverted>, or red border).

A user interface can be provided for enabling (e.g., setting), disabling, or moving to any of the way points. For example, after the operator clicks on a user interface element representing the way point, a dialog appears to determine if a new way point is being defined, the way point is to be disabled, or if the field of view is to be moved to the way point. Invalid options (e.g., moving to an undefined way point) need not be presented.

Move to Current Item

A feature is provided for moving the field of view to the currently-selected item. The field of view location of the item is saved when the origin tool is used.

Moving an Item to the Current Location

A feature is provided for moving an item to the current field of view location. The feature relies on past calibration and setting of an origin for the item. The move is implemented as a safe move (e.g., the item is retracted and then moved into view at the safe level). The item is left at the safe level and can then be positioned using the positioning tool.

Exemplary User Interface

A variety of arrangements are possible for presenting a user interface to the operator. The following describes an exemplary menu and window arrangement. The menus include file, edit, positioning, image, and options menus. The windows include a control and an image window.

TABLE 6
File Menu

| Menu Item | Description |
|---|---|
| save preference | Saves parameters (e.g., window positions and sizes |
| | and positioning parameters). Although the system |
| | automatically saves such parameters when the program |
| | quits, the save preference feature can be useful to save |
| | a significant amount of calibration work in case the |
| | operating system crashes during program operation |
| | (expected to be rare). |
| export error table | Exports the error table that accumulated due to turning |
| | on error recording in the options menu and using the |
| | origin or error tool of the image window. |
| export calib. table | Exports the calibration table accumulated as a result of |
| | performing the most recent calibration. |
| quit | Closes all files and returns to the operating system. |

TABLE 7
Edit Menu

| Menu Item | Description |
|---|---|
| undo origin | Removes the last origin operation in case a mistake was |
| | made |
| cut, copy, paste | standard clipboard functions |

TABLE 8
Positioning Menu

| Menu Item | Description |
|---|---|
| control window | This option opens the control window and brings |
| | it to the foreground. |
| define controllers ... | This option defines serial ports and controller |
| | types. |
| reset controllers | This option closes, reopens, and reinitializes all |
| | controllers and can be used if there is a problem |
| | during setup. |
| controller sign ... | This option inverts the sign of controllers so that |
| | the numeric keyboard and arrow keys work as |
| | expected. |
| lash corrections ... | This option defines the lash measured by moving |
| | controllers back and forth under high objective |
| | magnification. |
| velocity and | This option defines the velocity and acceleration |
| acceleration ... | of controllers. |
| extras ... | This option defines various parameters that affect |
| | the control window including the final approach |
| | while positioning. |
| initialize residual | This option sets the residual matrix to zero. If the |
| | residual matrix is being used in calculations, |
| | effectively forces the assumption that the model, |
| | the axis sign, and the orthogonality assumptions |
| | of the model are correct. |
| compute residual | This option computes the residual matrix from the |
| | parameters (e.g., theta, phi, and scale) and the |
| | total transformation matrix. |
| show residual | This option displays the residual matrix. This can |
| | be used to verify the positioning sign and |
| | orthogonality assumptions are correct. |
| edit item parameters | This option allows editing of declination angle |
| | theta, rotation angle phi, and the positioning sign |
| | of the current item. |
| edit displacement | This option allows editing of displacement that is |
| | normally defined by the origin tool. Although |
| | rare, situations can occur when manual editing is |
| | useful, such as when changing an item or moving |
| | the field of view has disabled the origin, the |
| | origin is known to still be valid, and the old origin |
| | is needed to position an offscreen item. |
| edit objective scale | This option allows editing the x, y, and z scale of |
| | the current objective. The x and y scales relate to |
| | the image dimensions, and the z scale relates to |
| | the focus controller. |
| initialize | This option estimates the total transformation to |
| transformation | permit positioning based on angles theta and phi |
| | (operator can provide) and the name of an |
| | objective that contains its magnification. An |
| | assumption can be made about the x and y scale |
| | factor with respect to the objective power (e.g., |
| | scale factor is 0.05 μm times the objective |
| | power). |
| compute | This option computes the transformation if, for |
| transformation | example, an objective parameter (e.g., z scale) |
| | has been improved using one manipulator and is |
| | to be applied to the current manipulator. |
| show transformation | This option displays the total transformation |
| | matrix. This option can be used to better |
| | parameters on the total transformation from |
| | manipulator to screen pixel. |

TABLE 9
Image Menu

| Menu Item | Description |
|---|---|
| image window | This option opens the image window and brings it to |
| | the foreground. |
| view camera | This option can re-start image acquisition if it stops |
| | due to a conflict with another imaging program, for |
| | example. |
| frame grabber ... | This option allows choosing among frame grabbers if |
| | more than one is installed. |
| image extras ... | This option presents a number of parameters relating to |
| | image display and the tools in the image window. |
| show markers | This option toggles on and off the display of |
| | calibration and origin markers |

TABLE 10
Options Menu

| Menu Item | Description |
|---|---|
| toggle joy enable | This option sets and clears the “joy enable” checkbox |
| | in the positioning window. It has a keyboard shortcut |
| | (e.g., command-J), which makes it easy to enable and |
| | disable the item joystick. |
| enable error | This option records origin and error tool clicks in a |
| recording | text file, as shown in the log file example above. |

Control Window

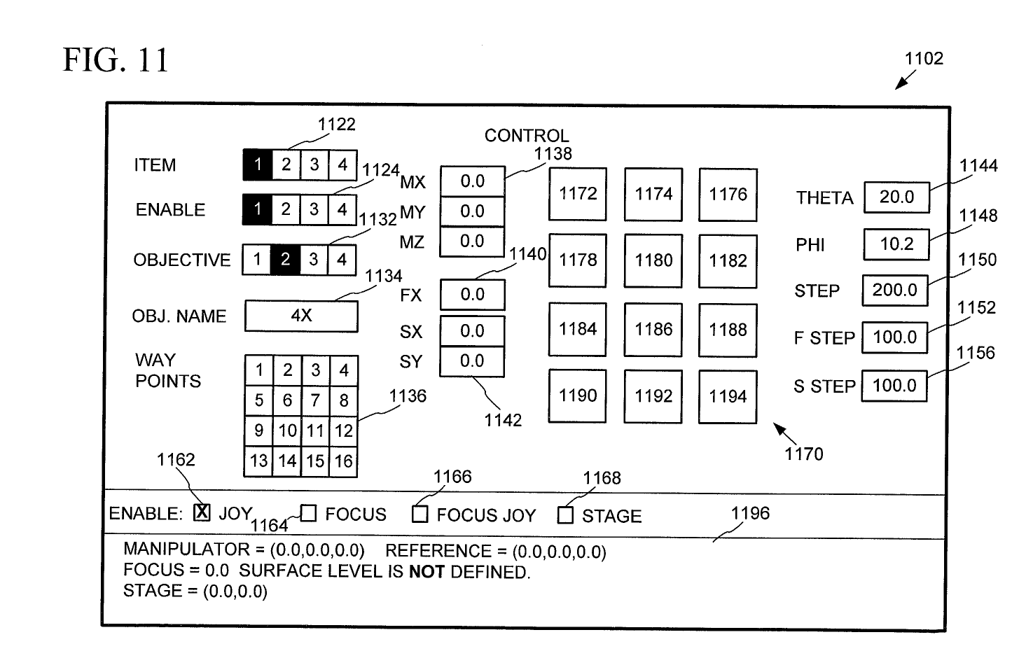

FIG. 11 shows a screen shot of an exemplary control window 1102 presented by a system as part of a graphical user interface. The item control 1122 allows selection of one of the items as a current item to be used, and the item enable 1124 allows items to be enabled/disabled. For disabled items, power can be removed from the item if it is powered and such a feature is supported by the controller hardware.

An objective control 1132 selects an objective. Information associated with the objective can be used to map pixels in the image window to a physical location in three-dimensional space. The objective name control 1134 allows an objective to be named (e.g., “50x”). The name is used in initial calibration, described above.

The way points control 1136 allows saving field of view locations and then moving back to the saved locations. The feature can be used to return to items or interesting features on the specimen being viewed.

The manipulator coordinates fields 1138 show the current location of an item in manipulator coordinates. The fields can also be used to enter new coordinates for use with the move tool.

The focus controller field 1 140 shows the current location of the focus controller and can also be used to enter a new coordinate with the move focus tool.

The field of view (e.g., microscope platform or stage) controller fields 1142 show the current location of the field of view and can also be used to enter new coordinates with the move tool.

The theta field 1144 is the declination angle of the manipulator's drive axis for an item with respect to the horizontal. The phi field 1148 is an angle of clockwise rotation about the z axis, looking down on the stage, starting from the left side.

The step field 1150 is the default step size for the numeric keypad that controls item manipulator controllers. The f step field 1152 is the default step size for the arrow keys that control the focus controller. The s step field 1156 is the default step size for the option arrow keys that control the microscope platform or stage controller.

The joy enable checkbox 1162 enables a manipulator's joystick. The checkbox focus enable checkbox 1164 enables the focus controller. Typically, the focus controller is enabled before it is used. The focus joy enable checkbox 1166 enables the focus controller's joystick. Some controllers have no joy enable command, so the manual control for the controller remains active. The stage enable checkbox 1168 enables the microscope platform or stage controller. Typically, the microscope platform or stage controller is enabled before it is used.

There are also a number of tools 1170 that can be used for various types of operations in response to being selected (e.g., clicked with a mouse pointer). The new item tool 1172 retracts the selected item along the drive axis far from the specimen so that it can be conveniently changed. The distance traveled is set in the extras dialog box in a field labeled “Distance to fully extract item.” After inserting the item on the manipulator, the joystick or numeric keyboard can be used to drive the item back to the specimen.

The set safe level tool 1174 sets the safe level to which an item is retracted before it can move to a new location. The retract item tool 1176 retracts the selected item along the x or z (depending on the selected positioning approach) axis to the safe level. From there, movements in x and y are safe. Movement in z is not necessarily safe. The retract items tool 1178 retracts the items along the drive axis to the safe level.

The toggle items tool 1180 permits changing of an objective. An icon for the tool can change to indicate the items are out of position. The distance traveled is set in the extras dialog. The toggle out enabled items tool 1182 works similar to the tool 1180, but retracts items that are enabled. If some of the items are already retracted, the tool retracts those that remain unretracted.

The move focus to item tool 1184 moves the focus controller to the item. The move focus to surface tool 1186 moves the focus controller to the surface of the specimen. The move focus to tool 1188 moves the controller to the location given by the coordinate fz 1140. The move stage to item tool 1190 moves the microscope platform or stage to view the current item's origin.

The move item to stage tool 1192 moves the current item to the current field of view location. The move stage to tool 1194 moves the microscope platform or stage controller given by the coordinates in fields 1142.

The message area 1196 can provide various status messages, coordinates after a move, and reminds the operator of the function of each tool if the mouse pointer is positioned over the tool. Item coordinates are given in manipulator and reference coordinates, in micrometers.

Image Window

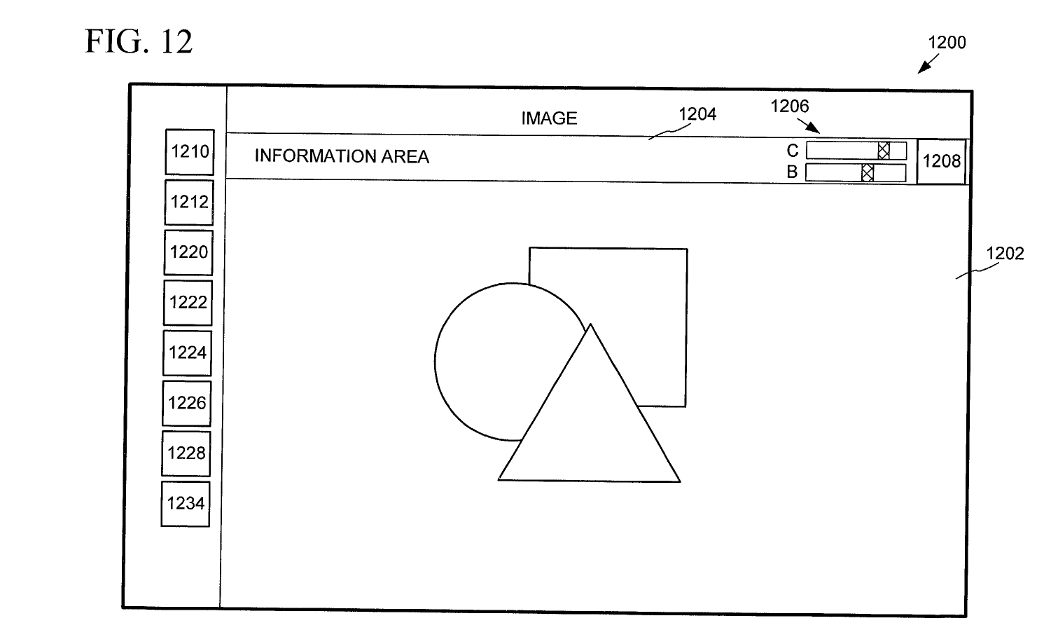

FIG. 12 shows a screen shot of an exemplary image window 1200 presented by a system as part of a graphical user interface. The image window 1200 includes a presentation of an image 1202, which represents at least a portion of a three-dimensional space observable by a microscope, including, for example, a specimen viewed under the microscope. The information area 1204 provides a variety of information, depending on the tool selected. The information area 1204 can also indicate the camera being used in multiple camera systems.

The contrast and brightness tools 1206 control the image display. Associations between pixels and colors can be changed, or, if a special key (e.g., the option key) is held down, the controls operate like those on a television set. A reset button 1208 is provided to reset contrast and brightness.

The arrow tool 1210 is used to select portions of the image. The measure tool 1212 is used to report on location and intensity of the image. For example, upon clicking on a point in the image, the information window might display “measure (203 μm, 54 μm, 129).” The information is dynamically updated as long as the pointer button is held down. The arrow tool 1210 can also be used to measure differences. By holding down a special key (e.g., the shift key) and then clicking and dragging when the arrow tool 1210 is activated, the location where the drag began is the zero reference. As the pointer is dragged, the numbers reflect the difference between the zero reference and the current pointer location.

The calibration tool 1220 is used to define calibration for subsequent positioning. It can be clicked once to start collecting points and then clicked again when completed.

The origin tool 1222 can be used to tie an item (e.g., the tip of a probe) to an image by selecting (e.g., clicking on) within the image at a location corresponding to the item (e.g., the pixel in the image corresponding to the probe's tip). Such an operation is also sometimes called “setting the origin.” A graphical indicator (e.g., a cross) shows where the origin has been placed within the graphical representation.

The error tool 1224 records the location of the item and image click point in reference coordinates and the percent difference as shown in the error recording feature above. The error tool 1224 can be used to test positioning accuracy.

The positioning tool 1226 is used to move the item to the current focus and pointer location indicated by the operator by clicking on the image 1202. The move is automatically made safe by retracting the item to the safe zone before it is reinserted into the item.

The zoom tool 1228 expands the image 1202, allowing an operator to view a specimen or item in greater detail. After the zoom tool 1228 is selected, the operator can click on an item of interest, and the display will expand by a factor of two about the object of interest. The process can be repeated to zoom in finer detail. The last zoom operation can be undone by holding down a special key (e.g., the option key) and clicking anywhere on the image 1202. Zooming can be removed by double clicking on the zoom or scroll tools.

The scroll tool 1234 shifts the image 1202 to view areas that are off the screen without affecting the zoom factor. When the scroll tool 1234 is selected, the operator can drag the image. The drag can be accelerated to avoid having to “pick up” the pointer (e.g., releasing the mouse button) and re-grabbing the image. Clicking on the image 1202 undoes the last series of scroll operations.

Keyboard Shortcuts

The following keyboard shortcuts can be defined for convenient operation via the keyboard. The keyboard shortcuts are typically activated in conjunction with a special key (e.g., by holding down a command, alt, control, or option key). Others are sufficient alone (e.g., the space bar and tab shortcuts):

TABLE 11
Keyboard Shortcuts

| Key | Operation |
|---|---|
| 1 | define controllers |
| 2 | reset controllers |
| 3 | controller sign |
| 4 | lash correction |
| 5 | velocity and acceleration |
| 6 | positioning extras |
| c | copy text |
| i | open image window |
| j | toggle joy enable |
| m | toggle show markers |
| p | print |
| q | quit |
| r | image extras |
| t | open positioning window |
| u | start image capture |
| v | paste |
| x | cut |
| . | stop image |
| space bar | switch among enabled manipulators |
| tab | switch among text fields in the positioning window |

Other shortcuts include a shift-drag for measuring distance with the measure tool 1212 and option click to unzoom with the zoom or hand tools.

Numeric Keypad and Arrow Keys

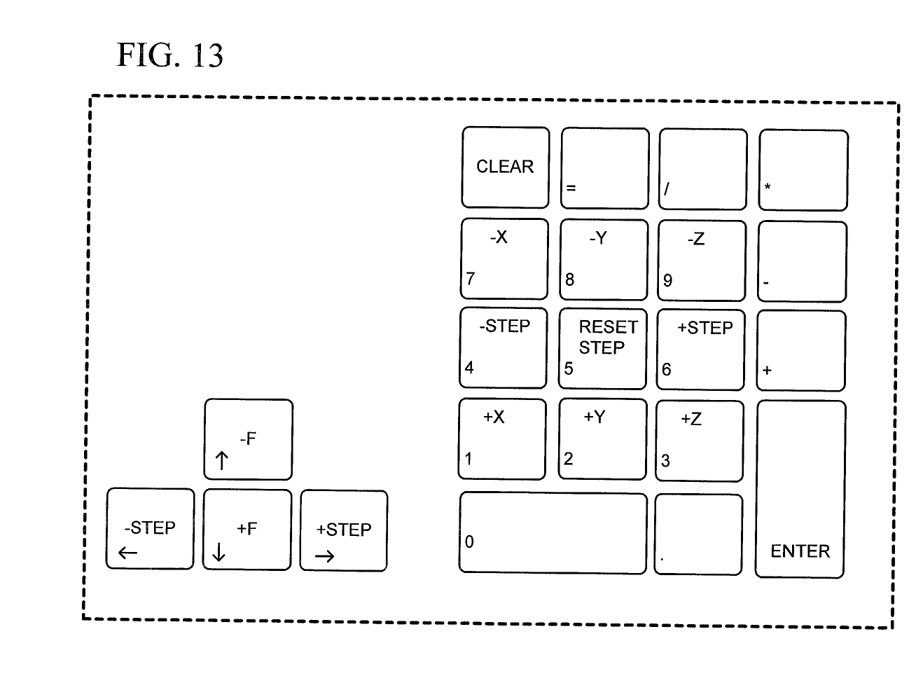

The numeric keypad and arrow keys can advantageously be assigned functionality for positioning items, focus, and the field of view. FIG. 13 shows an exemplary assignment of functionality to the keys. When a step button is pressed, the step size appears in the message area 1196 of the positioning window 1102. The step size modifications can be configured to not affect the step parameters elsewhere in the system. The field of view can be controlled by the arrow keys when a special key (e.g., the option key) is held down. The distance per step in μm is controlled by the s step parameter in the positioning window 1102. The f step parameter is controlled by the right and left arrow keys.

### Other Software Features

Included in the exemplary software for implementing the system is a set of various drivers. For example, a driver can be constructed for a manipulator controller. In this way, the software issues high-level directives to the driver, which then translates them into low-level directives to the controller for manipulation of the item. Manipulator controllers typically implement a proprietary interface for sending and retrieving information. So, different drivers are typically needed for manipulator controllers from different manufacturers.

The dialog between the manipulator controller driver and the manipulator controller can take a variety of forms. Some controllers send a constant stream of information, while others send information only when queried or when an operation is performed. The information sent to a micromanipulator controller can include, for example, three-dimensional positioning information to direct an item to a particular location in three-dimensional space with the micromanipulator.

The positioning system can be implemented as a plug in to existing commercial image analysis software. For image capture, it may be desirable to use image capture standards such as the TWAIN or QUICKTIME standards to facilitate use of different cameras supporting such standards.

Communication with controllers is typically achieved via serial line interfaces. A computer's operating system typically supports a serial line device controller, which facilitates convenient communication with a serial line device (e.g., the Creative Solutions products described above).

### Exemplary Operation

One scenario in which the exemplary systems and methods are particular useful is in the field of electroneurophysiology. For example, the electrical and chemical behavior of nerve cells can be observed by placing electrodes that measure electrical signals at various locations, such as around cells (e.g., to measure field potential) or inside cells (e.g., to measure action potential). Another technique, called “patch clamping,” can also be achieved by attaching an electrode to a nerve cell, sealing the electrode to the cell and “blowing out” the membrane within the tip of the electrode. Another technique called “voltage clamping” consists of holding the electrical potential constant by adjusting the amount of electrical current passed into the cell.

A biological specimen, such as a sample of brain tissue (e.g., hippocampus) can be placed under a microscope, and an electrode placed within the specimen to measure characteristics of the specimen. The specimen can be sliced, for example, to a thickness of 200-500 microns and viewed at 50x objective magnification. A micropipette carrying an electrode can be positioned at a location 100 microns below the surface to measure characteristics relating to the specimen. During such an experiment, it is also useful to view the biological specimen at other objective magnifications, such as 5× and 40×.

Multiple electrodes can be used, for example, in multiple cell experiments. In one experiment, four micromanipulators were mounted on the stage of a microscope to manipulate four electrodes. It should be noted that during calibration, it is important to focus on the tip of the electrode.

In cases where the graphical representation of the three-dimensional space observable by the microscope represents a region beneath the surface of a biological specimen being viewed under the microscope, positioning the item comprises directing the item beneath the surface of the biological specimen viewed under the microscope.

In addition to the above-described scenarios, the technologies have potentially broad application in the biomedical sciences and industry where visually-guided three-dimensional micropositioning operations are helpful for micromanipulation an probing of microscopic objects. Commercial biomedical applications include precision positioning of microelectrodes for electrophysiological recording from living cells, microinjection, and micromanipulation of biological cells for genetic engineering and microdelivery to living cells for drug testing and diagnostics of pharmacological and biological agents via a microdelivery mechanism.

The micromanipulation technologies also have potential for use in the microelectronics industry, such as for microelectronics fabrication and testing. Furthermore, the techniques can be combined with a virtual reality system to make it possible for a user wearing virtual reality glasses to reach out and touch a position within a virtual three-dimensional graphical representation of an object, thereby directing an item to the precise position on the actual object corresponding to the touched position on the virtual representation. Other computer-generated graphical representations can be used in conjunction with the above-described techniques.

### Alternatives

Although some of the above examples illustrate an implementation using matrices, the invention could be carried out in other ways (e.g., by using custom functions taking parameters to transform from one space into another). Also, the invention could be carried out without defining a plurality of spaces.

Also, the invention can be carried out without a camera. Instead, the system can be designed so the operator looks through the microscope oculars and sees a graphic overlay in the plane of focus. Such an arrangement is sometimes called a “heads up” display.

In view of the many possible embodiments to which the principles of the invention may be applied, it should be recognized that the illustrated embodiments are examples of the invention, and should not be taken as a limitation on the scope of the invention. Rather, the scope of the invention is defined by the following claims. We therefore claim as our invention all that comes within the scope and spirit of these claims.

We claim:

1. A computer-implemented method for positioning a moveable item within a three-dimensional space observable under a microscope, the method comprising:
presenting a graphical representation of at least a portion of the three-dimensional space;
receiving a user indication of a location within the graphical representation; and
positioning the moveable item at a three-dimensional location in the three-dimensional space corresponding to the location within the graphical representation.

2. The method of claim 1 wherein positioning is performed responsive to receiving the user indication of the location within the graphical representation.

3. The method of claim 1 further comprising:
transforming the location on the graphical location to values indicating the three-dimensional location in the three-dimensional space.

4. The method of claim 3 wherein an implicit value is associated with the graphical location and transforming comprises:
calculating the values indicating the three-dimensional location via the implicit value.

5. The method of claim 4 wherein the implicit value is a focus location.

6. The method of claim 1 further comprising:
after positioning the moveable item, receiving an indication of a location within the graphical representation where the item appears.

7. The method of claim 6 further comprising:
after receiving an indication of a location within the graphical representation where the item appears, automatically interpreting a next indication of a location within the graphical representation as a directive for positioning the item at a three-dimensional location corresponding to the location indicated.

8. The method of claim 1 wherein the graphical representation is a captured image depicting a field of view of the microscope.

9. The method of claim 1 wherein the graphical representation is viewed through oculars of the microscope.

10. The method of claim 1 wherein the item is a microdelivery mechanism for delivering a pharmacological agent, the method further comprising:
after positioning the item at the three-dimensional location, delivering the pharmacological agent via the microdelivery mechanism at the three-dimensional location.

11. The method of claim 1 wherein positioning the item comprises directing the item with a micromanipulator via directives sent from a computer.

12. The method of claim 11 wherein positioning the item further comprises sending three-dimensional positioning information to a micromanipulator controller for the micromanipulator.

13. The method of claim 1 wherein the graphical representation of the three-dimensional space represents a region beneath the surface of a biological specimen being viewed under the microscope; and
positioning the item comprises directing the item beneath the surface of the biological specimen viewed under the microscope.

14. The method of claim 1 wherein the graphical representation of the three-dimensional space represents a portion of the three-dimensional space being viewed under the microscope at an objective magnification between 5× and 63×.

15. The method of claim 1 wherein the graphical representation of the three-dimensional space represents a portion of the three-dimensional space being viewed under the microscope at an objective magnification between 40× and 63×.

16. The method of claim 1 wherein the graphical representation of the three-dimensional space represents a portion of the three-dimensional space being viewed under the microscope at an objective magnification greater than or equal to 40×.

17. The method of claim 1 wherein receiving a user indication of a location within the graphical representation comprises receiving an activation of a graphical pointer positioned at a location on a presented image.

18. The method of claim 1 wherein presenting a graphical representation of the three-dimensional space comprises presenting a two-dimensional video representation of the three-dimensional space on a video display device.

19. The method of claim 1 wherein presenting a graphical representation of the three-dimensional space comprises presenting an image generated from observation of a portion of the three-dimensional space under a microscope.

20. The method of claim 19 wherein positioning the item at a three-dimensional location within the three-dimensional space comprises the following:
determining focus information indicating at what location the microscope is focused; and
transforming the location within the graphical representation and the focus information into information for directing the item to the three-dimensional location within the three-dimensional space.

21. The method of claim 20 further comprising:
defining a plurality of mathematical spaces; and
determining a point corresponding to the three-dimensional location within the three-dimensional space by transforming a point from a first of the plurality of mathematical spaces to an equivalent point in a second of the plurality of mathematical spaces.

22. The method of claim 20 wherein transforming the location comprises:
transforming a three-dimensional location specified by a location within the graphical representation and the focus information into a non-orthogonal coordinate system for positioning the item at the three-dimensional location within the three-dimensional space.

23. The method of claim 19 wherein
positioning the item at a three-dimensional location within the three-dimensional space comprises the following:
determining depth information indicating at what depth the microscope is focused;
transforming the location within the graphical representation and the depth information into information in a coordinate system of a micromanipulator; and
sending the information in the coordinate system of the micromanipulator to the micromanipulator.

24. The method of claim 23 wherein transforming the location comprises:
transforming a three-dimensional location specified by a location within the graphical representation and the depth information into a non-orthogonal coordinate system for directing the moveable item to the three-dimensional location within the three-dimensional space, wherein the non-orthogonal coordinate system comprises a declined axis.

25. The method of claim 1 wherein the three-dimensional space includes a biological specimen, which is viewed under the microscope; and
positioning the item comprises positioning the item with respect to the biological specimen viewed under the microscope.

26. The method of claim 25 wherein the biological specimen is living.

27. The method of claim 25 wherein the biological specimen comprises brain tissue.

28. The method of claim 25 wherein the biological specimen comprises nerve tissue.

29. The method of claim 25 wherein the biological specimen comprises muscle tissue.

30. The method of claim 25 wherein the item is an electrode for measuring electrical signals.

31. The method of claim 1 further comprising:
collecting information indicating a safe zone for an object, wherein the safe zone indicates a zone within which the item can be moved without damage to the object;
wherein positioning the item comprises directing the item to a location within the safe zone before positioning the item at the three-dimensional location,

32. The method of claim 1 further comprising:
collecting information indicating a safe zone for an object under the microscope, wherein the safe zone indicates a zone within which the item can be moved without damage to the object; and
responsive to an indication by the user, directing the item to a location within the safe zone.

33. The method of claim 32 wherein the safe zone is defined as a zone that is a specified distance above a stage of the microscope.

34. The method of claim 32 wherein the safe zone is defined as a zone that is a specified distance above a surface of the object.

35. The method of claim 1 further comprising:
determining an implicit z depth based on a z depth related to the graphical representation of the portion of the three-dimensional space;
wherein positioning the item at a three-dimensional location within the three-dimensional space comprises the following:
converting the implicit z depth and the indicated location within the graphical representation into information in a three-dimensional coordinate system specifying a physical location within the three-dimensional space; and
sending the information in the coordinate system specifying the physical location within the three-dimensional space to a manipulator operable to move the item to the physical location within the three-dimensional space.

36. The method of claim 35 further comprising:
converting the physical location within the three-dimensional space into a three-dimensional coordinate system specifying the motor position of a motorized manipulator.

37. The method of claim 35 further comprising:
collecting calibration information for the converting.

38. The method of claim 37 wherein collecting calibration information comprises:
receiving a declination angle theta indicative of how far a drive axis for manipulating the item is declined from horizontal.

39. The method of claim 37 wherein collecting calibration information comprises:
receiving a rotational angle phi indicative of how far a drive axis for manipulating the moveable item is rotated about a z axis.

40. The method of claim 37 wherein collecting calibration information comprises:
generating a matrix for transforming a location within an image into a physical location within the three-dimensional space.

41. The method of claim 40 wherein the matrix is a homogeneous matrix.

42. The method of claim 37 wherein collecting calibration information comprises:
generating a matrix for transforming a physical location within the three-dimensional space into a motor position for a manipulator.

43. The method of claim 37 wherein collecting calibration information comprises:
for a plurality of points, performing the following:
directing the item to a point; and
receiving an indication of where on the image the item appears.

44. The method of claim 37 wherein collecting calibration information comprises:
for a plurality of points, performing the following:
under control of software, automatically directing the item to one of the points; and
receiving an indication of where on the image the item appears.

45. The method of claim 44 wherein automatically directing comprises jogging the relative to the point and returning to the point under control of software.

46. The method of claim 37 wherein collecting calibration information comprises incrementally collecting calibration information.

47. The method of claim 37 wherein collecting calibration information comprises:
for a plurality of points observed at different focus positions of a microscope, performing the following:
directing the item to the point;
focusing the microscope so the item appears in focus;
receiving an indication of where on the image the item appears; and
collecting the focus position of the microscope.

48. The method of claim 47 wherein the item is the tip of an electrode.

49. A computer-implemented method for directing a probe via a micromanipulator to a three-dimensional location within a specimen observed under a microscope, the method comprising:
capturing image data of the specimen from the microscope;
from the image data, generating a graphical image representing the specimen;
presenting the graphical image representing the specimen;
receiving an indication of a location on the graphical image, wherein the indication represents a location where the probe is to be moved;
determining a focus location indicative of where within the specimen the microscope is focused;
transforming the focus location and the location on the graphical image representing the specimen into a three-dimensional information for directing a micromanipulator to position the item at a corresponding location within the specimen; and
sending the three-dimensional information to the micromanipulator, whereby the item is positioned at a location within the specimen at a location corresponding to the location indicated on the graphical image representing the specimen.

50. A computer-readable medium comprising computer-executable instructions for positioning an item at a three-dimensional location with respect to a specimen observed under a microscope, the computer-readable medium comprising instructions for performing the following:
presenting a graphical representation of the specimen on a display device;
receiving a user indication of a location within the graphical representation; and
responsive to receiving the user indication of the location within the graphical representation, positioning the moveable item at a three-dimensional location with respect to the specimen corresponding to the location within the graphical representation.

51. A computer-implemented system for positioning an item at a three-dimensional location within a specimen, the system comprising:
a graphical presentation of a two-dimensional representation of the specimen, wherein the graphical presentation is operable to receive an indication of a location on the two-dimensional representation of the specimen;
a converter operable to convert the location on the two-dimensional representation of the specimen into three-dimensional information indicating the three-dimensional location within the specimen; and
a manipulation device operable to receive the three-dimensional information indicating the three-dimensional location within the specimen to position the item at the three-dimensional location indicated by the three-dimensional information.

52. The computer-implemented system of claim 51 wherein the item is an electrode.

53. The computer-implemented system of claim 51 wherein the manipulation device is a micromanipulator.

54. The computer-implemented system of claim 51 further comprising:
one or more additional manipulation devices operable to receive the three-dimensional information indicating the three-dimensional location within the specimen to direct one or more additional items to the three-dimensional location indicated by the three-dimensional information.

55. The computer-implemented system of claim 51 wherein the two-dimensional representation of the specimen comprises an image depicting a field of view of a microscope.

56. The computer-implemented system of claim 55 wherein the microscope is movable about a fixed stage.

57. A computer-implemented system for directing an item to a three-dimensional location within a specimen, the system comprising:
means for presenting a graphical representation of the specimen and accepting a user indication of a location within the graphical representation of the specimen;
means for directing the item to a specified three-dimensional location within the item; and
coupled to the means for presenting the graphical representation of the specimen and the means for directing the item, means for transforming the user indication of the location within the graphical representation of the specimen to a three-dimensional location within the item and operable to send the three-dimensional location to the means for directing the item to direct the item thereto.

58. The computer-implemented system of claim 57 wherein the graphical representation of the specimen is a representation of an image from a microscope, the system further comprising:
means for capturing the image from the microscope.
